(19) United States
(12) Patent Application Publication
(10) Pub. No.: US 2026/0054544 A1
(43) Pub. Date: Feb. 26, 2026

(54) VEHICULAR AIR CONDITIONER

(71) Applicant: Hanon Systems, Daejeon (KR)

(72) Inventors: Sang Il HWANG, Daejeon (KR); Tae Wan KIM, Daejeon (KR); Yong Eun SEO, Daejeon (KR); Tea Gun LEE, Daejeon (KR)

(73) Assignee: Hanon Systems, Daejeon (KR)

(21) Appl. No.: 19/099,734

(22) PCT Filed: Sep. 4, 2023
(86) PCT No.: PCT/KR2023/013121

§ 371 Date: Jan. 29, 2025

(30) Foreign Application Priority Data
Sep. 22, 2022 (KR) 10-2022-0120231
Sep. 22, 2022 (KR) 10-2022-0120238

(51) Int. Cl. B60H 1/00

(52) U.S. Cl. CPC B60H 1/00842; B60H 2001/002

(57) ABSTRACT

A vehicular air conditioner includes a console duct and a rear floor duct configured to blow air discharged from a front seat blower to a rear seat passenger side and a rear floor side, respectively, a rear seat mode door configured to control air distribution from the front seat blower to the console duct and the rear floor duct, a rear seat blower installed in the console duct so as to increase an air flow rate and air pressure of the air blown to the rear seat passenger side, a rear seat console door installed in an internal passage of the console duct so as to adjust the air flow rate of air blown to the rear seat passenger side along the console duct, and a control part configured to control an opening position of the rear seat console door with respect to the console duct.

### TECHNICAL FIELD

The present invention relates to a vehicular air conditioner, and more particularly, a vehicular air conditioner configured to independently control the air flow rate on the console duct side so that the air flow rate on the rear seat passenger side through the console duct can be accurately controlled according to a preset value and a preset air flow rate level.

### BACKGROUND ART

Recently, an individual air conditioner that independently cools and heats multiple regions in a passenger room has been developed. For example, a front/rear seat individual air conditioner that independently cools and heats a front seat region and a rear seat region in a passenger room has been developed and used.

As shown in FIG. 1, the front/rear seat individual air conditioner includes a console vent 5 and a rear floor vent 7 for discharging air in a cooling heat exchanger 1 and air in a heating heat exchanger 3 toward a rear seat passenger and a rear floor, respectively.

The console vent 5 and the rear floor vent 7 discharge cold air in a rear cold air passage 1a that has passed through the cooling heat exchanger 1 and hot air in a hot air passage 3a that has passed through the heating heat exchanger 3 toward the console duct 8 and rear floor duct 9.

Accordingly, the cold and the hot air in the cooling heat exchanger 1 and the heating heat exchanger 3 can be blown to the rear seat passenger and the rear floor, respectively, through the console duct 8 and the rear floor duct 9, thereby cooling and heating the rear seat region in the passenger room.

The front/rear seat individual air conditioner further includes a rear seat mode door 10 installed at a branch point between the console vent 5 and the rear floor vent 7, and a rear seat blower 12 installed on the console duct 8.

The rear seat mode door 10 rotates between the console vent 5 and the rear floor vent 7 to adjust the opening degrees of the console vent 5 and the rear floor vent 7.

In particular, the rear seat mode door 10 adjusts the opening degrees of the console vent 5 and the rear floor vent 7 according to the rear seat air discharge mode status.

For example, when the rear seat air discharge mode is a vent mode, the console vent 5 is controlled to be opened and the rear floor vent 7 is controlled to be closed. Accordingly, cold air or hot air can be blown toward the torso of a rear seat passenger.

When the rear seat air discharge mode is a floor mode, the console vent 5 is controlled to be closed and the rear floor vent 7 is controlled to be opened. Accordingly, cold air or hot air can be blown toward the floor of the rear seat region.

When the rear seat air discharge mode is a bi-level mode, the console vent 5 and the rear floor vent 7 are controlled to be opened simultaneously. Accordingly, cold air and hot air can be simultaneously blown toward the torso of a rear seat passenger and the rear floor.

Unlike the front seat blower (not shown) that sucks air outside the air conditioning case 14, the rear seat blower 12 sucks air inside the air conditioning case 14, thereby additionally increasing the air flow rate and air pressure of the air blown toward a rear seat passenger along the console duct 8.

Therefore, by increasing the air flow rate and air pressure of the air blown toward a rear seat passenger, the cooling and heating performance for the rear seat region is improved.

However, such a conventional air conditioner has a disadvantage in that it is very difficult and tricky to precisely control the air flow rate according to the preset air flow rate level because the air flow rate on the console duct 8 side of the air blown toward a rear seat passenger is simultaneously affected by the front seat blower and the rear seat blower 12.

In particular, the front seat blower is controlled based on a preset front seat side air flow rate level. Therefore, there is a disadvantage in that it is very difficult to match the air flow rate on the console duct 8 side to a preset rear seat air flow rate level due to the air flow rate in the front seat blower controlled based on the preset front seat air flow rate level.

Due to such a disadvantage, when the rear seat air discharge mode is set to a vent mode, there is a problem that the air flow rate in the console duct 8 cannot be controlled to a preset value, and as a result, the discharged air flow rate on the rear seat passenger side is not controlled to a preset air flow rate level.

In addition, under the rear seat vent mode condition, the air flow rate levels of the front seat blower and rear seat blower 12 may vary depending on the user or the internal/external temperature conditions.

In this case, there is a disadvantage in that the air flow rate on the console duct 8 side cannot be accurately controlled in response to the variable air flow rate levels of the front seat blower and the rear seat blower 12.

In particular, since the front seat blower is controlled based on the preset front seat side air flow rate level, when the air flow rate level of the front seat blower is changed due to a change in the preset front seat side air flow rate level, there is a disadvantage in that the air flow rate on the console duct 8 side cannot be accurately controlled in response to the changed air flow rate in the front seat blower.

Due to such a disadvantage, the air flow rate on the console duct 8 side cannot be controlled to a preset value, and as a result, the discharged air flow rate on the rear seat passenger side is not controlled to the preset air flow rate level, resulting in a problem in that the comfort in the rear seat region is significantly reduced.

In addition, in the conventional air conditioner, the air flow rate on the rear floor duct 9 side of the air blown to toward the rear floor is determined by the front seat blower of the air conditioning case 14, and the air flow rate on the console duct 8 side of the air blown toward the rear seat passenger is determined by the front seat blower and the rear seat blower 12.

Accordingly, there is a disadvantage in that it is very difficult and tricky to precisely control the air flow rate on the rear floor duct 9 side and the air flow rate on the console duct 8 side to preset values through the control of the front seat blower and the rear seat blower 12.

In particular, when the rear seat air discharge mode is a bi-level mode, the air flow rate distribution between the rear floor duct 9 side and the console duct 8 side must be accurately controlled to the preset values, so that the discharged air flow rates on the rear floor side and the rear seat passenger side can be accurately controlled to preset air flow rate levels.

However, since the air flow rate on the console duct 8 side is affected by the front seat blower and the rear seat blower 12 at the same time, there is a disadvantage in that it is difficult to control the air flow rate to a preset value.

Due to such a disadvantage, there is a problem in that it is very difficult to accurately control the air flow rate distribution between the rear floor duct 9 side and the console duct 8 side according to a preset value.

Furthermore, since the front seat blower is controlled based on the preset front seat side air flow rate level, there is a disadvantage in that it is very difficult to match the air flow rate on the rear floor duct 9 side and the air flow rate on the console duct 8 side to a preset rear seat side air flow rate level due to the air flow rate in the front seat blower controlled based on the preset front seat side air flow rate level in this way.

Due to such a disadvantage, when the rear seat air discharge mode is set to the bi-level mode, the air flow rate distribution between the rear floor duct 9 side and the console duct 8 side cannot be controlled to a preset value, and as a result, there is a problem in that the discharged air flow rate on the rear floor side and the discharged air flow rate on the rear seat passenger side are not controlled to the preset air flow rate levels.

In addition, under the rear seat bi-level mode condition, the air flow rate levels of the front seat blower and the rear seat blower 12 may vary depending on the user or the internal/external temperature conditions.

In this case, there is a disadvantage in that the air flow rate on the rear floor duct 9 side and the air flow rate on the console duct 8 side cannot be accurately controlled in response to the variable air flow rate levels of the front seat blower and the rear seat blower 12.

In particular, since the front seat blower is controlled based on the preset front seat side air flow rate level, when the air flow rate level in the front seat blower is changed due to a change in the preset front seat side air flow rate level, there is a disadvantage in that the air flow rate on the rear floor duct 9 side and the air flow rate on the console duct 8 side cannot be accurately controlled in response to the changed air flow rate in the front seat blower.

Due to such a disadvantage, the air flow rate distribution between the rear floor duct 9 side and the console duct 8 side cannot be controlled according to the preset ratio, and as a result, there is a problem in that the discharged air flow rates on the rear floor side and the rear seat passenger side are not controlled according to the preset air flow rate levels.

After all, due to the above-mentioned problems, there is a disadvantage in that the air flow rate and air flow rate level on the rear floor side and the rear seat passenger side under the rear seat bi-level mode condition are not controlled to the preset state. Due to this disadvantage, there is a problem that the comfort in the rear seat region is significantly reduced.

### DETAILED DESCRIPTION OF THE INVENTION

### Technical Task

In view of the problems inherent in the prior art, it is an object of the present invention to provide a vehicular air conditioner capable of individually controlling an air flow rate on a console duct side.

Another object of the present invention is to provide a vehicular air conditioner capable of precisely controlling the air flow rate of the air blown to a rear seat passenger side through a console duct according to a preset value and a preset air flow rate level, by adopting a configuration in which the air flow rate on the console duct side can be individually controlled

Another object of the present invention is to provide a vehicular air conditioner capable of allowing the air flow rate and the air flow rate level on the rear seat passenger side to be controlled to preset values in a rear seat vent mode and improving the comfort in a rear seat region, by adopting a configuration in which the air flow rate on the console duct side can be accurately controlled to a preset value in the rear seat vent mode.

Another object of the present invention is to provide a vehicular air conditioner capable of variably controlling the air flow rate on the console duct side according to the air flow rate levels of a front blower and a rear blower in a rear seat vent mode.

Another object of the present invention is to provide a vehicular air conditioner capable of actively responding to a change in the air flow rate on the console duct side that occurs according to a change in the air flow rate levels of a front seat blower and a rear seat blower under a rear seat vent mode condition, by adopting a configuration in which the air flow rate on the console duct side can be variably adjusted according to the air flow rate levels of the front seat blower and the rear seat blower in a rear seat vent mode.

Another object of the present invention is to provide a vehicular air conditioner capable of compensating for a change in the air flow rate on the rear seat passenger side that occurs when the air flow rate levels of a front seat blower and a rear seat blower are changed, by actively responding to a change in the air flow rate on the console duct side that occurs according to a change in the air flow rate levels of the front seat blower and the rear seat blower under a rear seat vent mode condition.

Another object of the present invention is to provide a vehicular air conditioner capable of controlling the discharged air flow rate on the rear seat passenger side according to a preset air flow rate level regardless of the change in the air flow rate levels of a front seat blower and a rear seat blower in a rear seat vent mode, by compensating for the change in the air flow rate on the rear seat passenger side that occurs when the air flow rate levels of the front seat blower and the rear seat blower are changed under a rear seat vent mode condition.

Another object of the present invention is to provide a vehicular air conditioner capable of individually controlling the air flow rate on the rear floor duct side and the air flow rate on the console duct side.

Another object of the present invention is to provide a vehicular air conditioner capable of accurately controlling the air flow rate of the air blown to the rear floor side through a rear floor duct and the air flow rate of the air blown to the rear seat passenger side through a console duct according to a preset value and an air flow rate level, by adopting a configuration in which the air flow rate of the air blown to the rear floor side and the air flow rate of the air blown to the rear seat passenger side can be individually controlled.

Another object of the present invention is to provide a vehicular air conditioner capable of precisely controlling the air flow rate distribution between the rear floor duct side and the console duct side and the respective air flow rates according to preset values in a rear seat bi-level mode, by adopting a configuration in which the air flow rate on the rear floor duct side and the air flow rate on the console duct side can be individually adjusted in a systematically controlled manner.

Another object of the present invention is to provide a vehicular air conditioner capable of controlling the air flow rates and the air flow rate levels on the rear floor side and the rear seat passenger side to preset values in a rear seat bi-level mode and improving the comfort in the rear seat region, by adopting a configuration in which the air flow rate distribution between the rear floor duct side and the console duct side and the respective air flow rates can be accurately controlled to the preset values in the rear seat bi-level mode.

Another object of the present invention is to provide a vehicular air conditioner capable of variably controlling the air flow rate on the rear floor duct side and the air flow rate on the console duct side, respectively, depending on the air flow rate levels of a front seat blower and a rear seat blower in a rear seat bi-level mode.

Another object of the present invention is to provide a vehicular air conditioner capable of actively responding to a change in the air flow rate on the rear floor duct side and the air flow rate on the console duct side that occurs according to the change in the air flow rate levels of the front seat blower and the rear seat blower under a rear seat bi-level mode condition, by adopting a configuration in which the air flow rate on the rear floor duct side and the air flow rate on the console duct side can be variably controlled according to the air flow rate levels of the front seat blower and the rear seat blower in the rear seat bi-level mode.

Another object of the present invention is to provide a vehicular air conditioner capable of compensating for a change in the air flow rate on the rear floor side and the rear seat passenger side that occurs when the air flow rate levels of the front seat blower and the rear seat blower are changed, by actively responding to the change in the air flow rate on the rear floor duct side and the console duct side that occurs according to the change in the air flow rate levels of the front seat blower and the rear seat blower under the rear seat bi-level mode condition.

Another object of the present invention is to provide a vehicular air conditioner capable of controlling the discharged air flow rates on the rear floor side and the rear seat passenger side according to preset air flow rate levels regardless of the change in the air flow rate levels of the front seat blower and the rear seat blower in the rear seat bi-level mode, by compensating for the change in the air flow rates on the rear floor side and the rear seat passenger side that occur when the air flow rate levels of the front seat blower and the rear seat blower are changed under the rear seat bi-level mode condition.

### Means to Solve the Task

In order to achieve these objects, there is provided a vehicular air conditioner, including: a console duct and a rear floor duct configured to blow air discharged from a front seat blower to a rear seat passenger side and a rear floor side, respectively; a rear seat mode door configured to control air distribution from the front seat blower to the console duct and the rear floor duct; a rear seat blower installed in the console duct so as to increase an air flow rate and an air pressure of the air blown to the rear seat passenger side; a rear seat console door installed in an internal passage of the console duct so as to adjust the air flow rate of air blown to the rear seat passenger side along the console duct; and a control part configured to control an opening position of the rear seat console door with respect to the console duct so as to blow the air to the rear seat passenger side at an air flow rate corresponding to a preset air flow rate level.

The rear seat console door may be installed on the internal flow path of the console duct on the upstream side of the rear seat blower.

The control part may be configured to, when a rear seat air discharge mode is a rear seat vent mode, control the opening position of the rear seat console door with respect to the console duct according to air flow rate levels of the front seat blower and the rear seat blower, so that the air can be blown to the rear seat passenger side at an air flow rate corresponding to the rear seat vent mode and the preset air flow rate level.

The control part may be configured to constantly control the opening position of the rear seat console door with respect to the console duct to a preset position under a condition that the air flow rate level of the front seat blower is equal to or lower than the air flow rate level of the rear seat blower in the rear seat vent mode.

Under a condition that the air flow rate level of the front seat blower exceeds the air flow rate level of the rear seat blower in the rear seat vent mode, the control part may control the opening position of the rear seat console door with respect to the console duct to a position where the console duct is closed more than under a condition that the air flow rate level of the front seat blower is equal to or lower than the air flow rate level of the rear seat blower.

Under a condition that the air flow rate level of the front seat blower exceeds the air flow rate level of the rear seat blower in the rear seat vent mode, the control part may control the opening position of the rear seat console door so as to gradually block the console duct in inverse proportion to an increase in a difference between the air flow rate levels of the front seat blower and the rear seat blower.

The control part may be configured to control an on/off operation of the rear seat blower according to the air flow rate levels of the front seat blower and the rear seat blower in the rear seat vent mode.

The control part may be configured to control an opening position of the rear seat console door with respect to the console duct and an opening position of the rear seat mode door with respect to the console duct and the rear floor duct so as to blow the air toward the rear floor side and the rear seat passenger side at an air flow rate that matches a current rear seat air discharge mode and a preset air flow rate level.

When the rear seat air discharge mode is a bi-level mode, the control part may systematically control the rear seat mode door and the rear seat console door according to the air flow rate levels of the front seat blower and the rear seat blower so as to blow the air toward the rear floor side and the rear seat passenger side at an air flow rate that matches the rear seat bi-level mode and the preset air flow rate level.

The control part may be configured to constantly control the opening position of the rear seat mode door with respect to the rear floor duct and the opening position of the rear seat console door with respect to the console duct to preset positions under a condition that the air flow rate level of the front seat blower is equal to or lower than the air flow rate level of the rear seat blower in the rear seat bi-level mode.

Under a condition that the air flow rate level of the front seat blower exceeds the air flow rate level of the rear seat blower in the rear seat bi-level mode, the control part may control the opening position of the rear seat mode door with respect to the rear floor duct to a position where the rear floor duct is closed more than under a condition that the air flow rate level of the front seat blower is equal to or lower than the air flow rate level of the rear seat blower.

Under a condition that the air flow rate level of the front seat blower exceeds the air flow rate level of the rear seat blower in the rear seat bi-level mode, the control part may control the opening position of the rear seat console door with respect to the console duct to a position where the console duct is closed more than under a condition that the air flow rate level of the front seat blower is equal to or lower than the air flow rate level of the rear seat blower.

### Effect of the Invention

According to the vehicular air conditioner according to the present invention, since the rear seat console door is installed on the console duct side and the rear seat console door is individually controlled by the control part, it is possible to individually control the air flow rate on the console duct side.

In addition, since the air flow rate on the console duct side can be individually adjusted, the air flow rate of the air blown toward the rear seat passenger side through the console duct can be precisely controlled according to the preset value and the preset air flow rate level.

In addition, since the rear seat console door is individually controlled, the air flow rate on the console duct side can be accurately controlled to the preset value in the rear seat vent mode.

In addition, since the air flow rate on the console duct side can be precisely controlled to the preset value in the rear seat vent mode, the blown air flow rate and the air flow rate level on the rear seat passenger side can be controlled to the preset values in the rear seat vent mode, thereby improving the comfort in the rear seat region.

In addition, since the rear seat console door is controlled according to the air flow rate levels of the front seat blower and the rear seat blower in the rear seat vent mode, the air flow rate on the console duct side can be variably adjusted according to the air flow rate levels of the front seat blower and the rear seat blower in the rear seat vent mode.

In addition, since the air flow rate on the console duct side can be variably adjusted according to the air flow rate levels of the front seat blower and the rear seat blower in the rear seat vent mode, it is possible to actively respond to the change in the air flow rate on the console duct side that occurs according to the change in the air flow rate levels of the front seat blower and the rear seat blower under the rear seat vent mode condition.

In addition, since it is possible to actively respond to the change in the air flow rate on the console duct side that occurs according to the change in the air flow rate levels of the front seat blower and rear seat blower under the rear seat vent mode condition, it is possible to compensate for the change in the air flow rate on the rear seat passenger side that occurs when the air flow rates in the front seat blower and rear seat blower are changed.

In addition, since it is possible to compensate for the change in the air flow rate on the rear seat passenger side that occurs when the air flow rate levels of the front seat blower and the rear seat blower are changed under the rear seat vent mode condition, the discharged air flow rate on the rear seat passenger side can be controlled to match the preset air flow rate level regardless of the change in the air flow rate levels of the front seat blower and the rear seat blower in the rear seat vent mode.

In addition, since the rear seat console door is installed on the console duct side and the rear seat console door and the rear seat mode doors are individually controlled by the control part, it is possible to individually control the air flow rate on the rear floor duct side and the air flow rate on the console duct side.

In addition, since the air flow rate on the rear floor duct side and the air flow rate on the console duct side can be individually controlled, the air flow rate of the air blown to the rear floor side through the rear floor duct and the air flow rate of the air blown to the rear seat passenger side through the console duct can be precisely controlled according to the preset value and the preset air flow rate level.

In addition, since the rear seat console door and the rear seat mode doors are individually controlled in a systematically controlled manner, the air flow rate distribution between the rear floor duct side and the console duct side and the respective air flow rates can be precisely controlled to the preset values in the rear seat bi-level mode.

In addition, since the air flow rate distribution between the rear floor duct side and the console duct side and the respective air flow rates can be precisely controlled to the preset values in the rear seat bi-level mode, the air flow rate and the air flow levels on the rear floor side and the rear seat passenger side can be controlled to the preset values in the rear seat bi-level mode, thereby improving the comfort in the rear seat region.

In addition, since the rear seat console door and the rear seat mode doors are systematically controlled according to the air flow levels of the front seat blower and the rear seat blower in the rear seat bi-level mode, the air flow rate on the rear floor duct side and the air flow rate on the console duct side can be variably adjusted according to the air flow levels of the front seat blower and the rear seat blower in the rear seat bi-level mode.

In addition, since the air flow rate on the rear floor duct side and the air flow rate on the console duct side can be variably controlled according to the air flow rate levels of the front seat blower and the rear seat blower in the rear seat bi-level mode, it is possible to actively respond to a change in the air flow rate on the rear floor duct side and the air flow rate on the console duct side that occurs according to the change in the air flow rate levels of the front seat blower and the rear seat blower under the rear seat bi-level mode condition.

In addition, since it is possible to actively respond to the change in the air flow rate on the rear floor duct side and the air flow rate on the console duct side that occurs according to the change in the air flow rate levels of the front seat blower and the rear seat blower under the rear seat bi-level mode condition, it is possible to compensate for the changes in the air flow rates on the rear floor side and the rear seat passenger side that occur when the air flow rate levels of the front seat blower and the rear seat blower are changed.

In addition, since it is possible to compensate for the changes in the air flow rates on the rear floor side and the rear seat passenger side that occur when the air flow rate levels of the front seat blower and the rear seat blower are changed under the rear seat bi-level mode condition, the discharged air flow rates on the rear floor side and the rear seat passenger side can be controlled to match the preset air flow rate levels regardless of the change in the air flow rate levels of the front seat blower and the rear seat blower in the rear seat bi-level mode.

### BRIEF DESCRIPTION OF THE DRAWINGS

FIG. 1 is a side sectional view showing a conventional vehicular air conditioner.

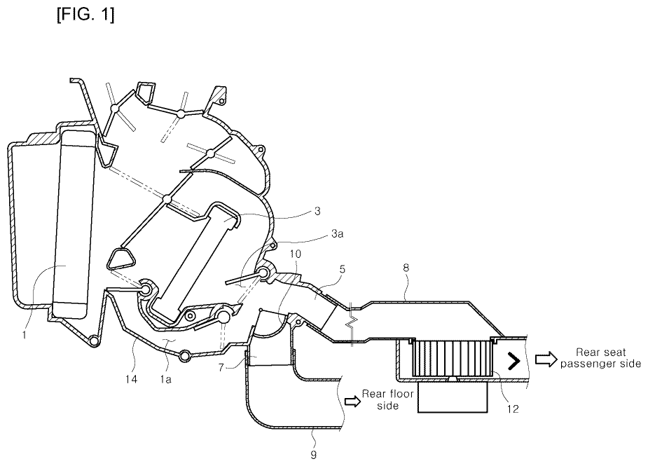

FIG. 2 is a side sectional view showing a vehicular air conditioner according to a first embodiment of the present invention.

FIG. 3 is a side sectional view showing a vehicular air conditioner according to a second embodiment of the present invention.

### BEST MODE TO IMPLEMENT THE INVENTION

Preferred embodiments of a vehicular air conditioner according to the present invention will now be described in detail with reference to the accompanying drawings (The same components as those of the prior art described above are designated by like reference numerals).

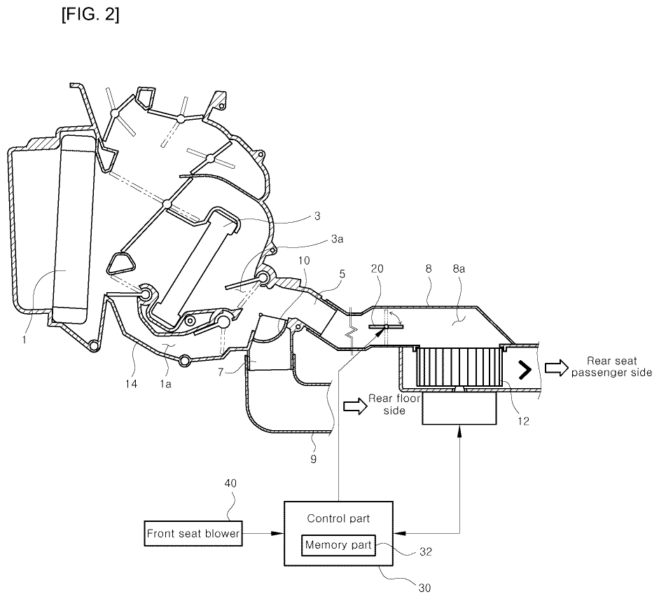

Prior to describing the features of the vehicular air conditioner according to the present invention, a front/rear seat individual air conditioner will be briefly described with reference to FIG. 2.

The front/rear seat individual air conditioner includes a console vent 5 and a rear floor vent 7 for discharging air from a cooling heat exchanger 1 and a heating heat exchanger 3 to the passenger side and the floor side, respectively, in a rear seat region.

The console vent 5 and the rear floor vent 7 discharge cold air in a rear cold air passage 1a that has passed through the cooling heat exchanger 1 and hot air in a hot air passage 3a that has passed through the heating heat exchanger 3 to a console duct 8 and a floor duct 9 sides, respectively.

Accordingly, the cold air from the cooling heat exchanger 1 and the hot air from the heating heat exchanger 3 can be blown to the passenger side and the floor side, respectively, in the rear seat region through the console duct 8 and the rear floor duct 9, so that the rear seat region of a passenger room can be cooled and heated.

The front/rear seat individual air conditioner further include a rear seat mode door 10 installed at a branch point between the console vent 5 and the rear floor vent 7, and a rear seat blower 12 installed on the console duct 8.

The rear seat mode door 10 rotates between the console vent 5 and the rear floor vent 7 to control the opening amount of the console vent 5 and the opening amount of the rear floor vent 7. In particular, the air distribution between the console duct 8 and the rear floor duct 9 is controlled by controlling the opening amount of the console vent 5 and the opening amount of the rear floor vent 7 according to a rear seat air discharge mode status.

The rear seat blower 12 additionally increases the air flow rate and the air pressure of the air blown toward the passenger side of the rear seat region along the console duct 8. Accordingly, it is possible to increase the air flow rate and the air pressure of the air blown toward the passenger torso side in the rear seat region.

### First Embodiment

Next, the features of the vehicular air conditioner according to a first embodiment of the present invention will be described in detail with reference to FIG. 2.

First, the air conditioner of the present invention further includes a rear seat console door 20 installed in the internal flow path 8a of the console duct 8 on the upstream side of the rear seat blower 12.

The rear seat console door 20 is a flat door that rotates in response to a control signal of a control part 30 described later to adjust the opening amount of the internal flow path 8a of the console duct 8.

Therefore, the air flow rate of the air blown toward the rear seat passenger torso along the console duct 8 is controlled.

In particular, the air flow rate of the air blown toward the rear seat passenger torso is independently controlled. Thus, the air flow rate of the air blown to the rear seat passenger side can be controlled according to a preset value and a preset air flow rate level.

The air conditioner of the present invention includes a control part 30 that controls the rear seat console door 20.

The control part 30 is equipped with a microprocessor and is configured to control the opening amount of the rear seat console door 20 according to the air flow rate levels of the front seat blower 40 and the rear seat blower 12, so as to blow air that matches the current rear seat air discharge mode and the preset air flow rate level toward the rear seat passenger.

In particular, when the rear seat air discharge mode is a vent mode, the opening degree of the rear seat console door 20 for the internal flow path 8a of the console duct 8 is controlled according to the air flow rate levels of the front seat blower 40 and the rear seat blower 12.

Therefore, the air flow rate corresponding to the rear seat vent mode condition and the air flow rate level condition set by the user or the internal/external temperature condition can be blown to the rear seat passenger.

In more detail, the control part 30 includes a memory part 32.

As shown in Table 1 below, the memory part 32 stores a mapping table that indicates the control values of the opening position of the rear seat console door for the air flow rate levels of the front seat blower and the rear seat blower in the rear seat vent mode.

TABLE 1
The control values of the opening position of the rear seat console
door for the air flow rate levels of the front seat blower and
the rear seat blower under the rear seat vent mode condition
(console duct internal flow path opening amount: K > L >
M > N > O > P > Q > R)

| Control value of opening | | | | | | | | | |
|---|---|---|---|---|---|---|---|---|---|
| position of rear seat | | Air flow rate level of front seat blower | | | | | | | |
| console door (V) | | 1 | 2 | 3 | 4 | 5 | 6 | 7 | 8 |
| Air flow rate level | 1 | K | L | M | N | O | P | Q | R |
| of rear seat blower | 2 | K | K | L | M | N | O | P | Q |
| | 3 | K | K | K | L | M | N | O | P |
| | 4 | K | K | K | K | L | M | N | O |
| | 5 | K | K | K | K | K | L | M | N |
| | 6 | K | K | K | K | K | K | L | M |
| | 7 | K | K | K | K | K | K | K | L |
| | 8 | K | K | K | K | K | K | K | K |

The control values of the opening position of the rear seat console door for the air flow rate levels of the front seat blower and the rear seat blower are correction values of the opening position of the rear seat console door 20 for correcting the air flow rates of the air blown to the rear seat passenger side and changed depending on the air flow rate levels of the front seat blower 40 and the rear seat blower 12 in the rear seat vent mode to match preset rear seat air flow rate levels, and are stored differently for the air flow rate levels of the front seat blower 40 and the rear seat blower 12.

The control part 30 determines whether the current rear seat air discharge mode is a vent mode. If it is determined that the current rear seat air discharge mode is the vent mode, the control part 30 detects from a memory part 32 the control value of the opening position of the rear seat console door corresponding to the current air flow rate level of the front seat blower and the current air flow rate level of the rear seat blower inputted from the front seat blower 40 and the rear seat blower 12.

When the control value of the opening position of the rear seat console door has been detected, the control part 30 variably controls the opening position of the rear seat console door 20 based on the detected control value of the opening position of the rear seat console door.

In particular, the control part 30 controls the opening position of the rear seat console door 20 for the internal flow path 8a of the console duct 8.

Accordingly, when the air flow rate levels of the front seat blower 40 and the rear seat blower 12 are varied by the user settings or the internal/external temperature conditions in the rear seat vent mode, and the air flow rate of the air blown to the rear seat passenger side is changed differently from the preset rear seat air flow rate level, the opening position of the rear seat console door 20 can be corrected in response thereto.

Thus, the discharged air flow rate on the rear seat passenger side can be corrected to match the preset air flow rate level even when the air flow rate levels of the front seat blower 40 and the rear seat blower 12 are varied in the rear seat vent mode.

As a result, regardless of the change in the air flow rate level of the front seat blower 40 and the rear seat blower 12, the discharged air flow rate on the rear seat passenger side is controlled to match a preset air flow rate level, thereby keeping the rear seat region comfortable.

Meanwhile, as shown in Table 1 that shows the rear seat console door opening position control values for the air flow rate levels of the front seat blower and the rear seat blower under the rear seat vent mode condition stored in the memory part 32, the rear seat console door opening position control values are stored as preset default values K under the condition that the air flow rate level of the front seat blower 40 is equal to or lower than the air flow rate level of the rear seat blower 12, i.e., under the condition that the air flow rate level of the front seat blower 40 is not higher than the air flow rate level of the rear seat blower 12.

Accordingly, under the condition that the air flow rate level of the front seat blower 40 is equal to or lower than the air flow rate level of the rear seat blower 12, the opening position of the rear seat console door 20 with respect to the internal flow path 8a of the console duct 8 is constantly controlled to a preset position regardless of the air flow rates of the front seat blower 40 and the rear seat blower 12.

The reason for adopting this configuration is that, under the condition that the air flow rate level of the front seat blower 40 is equal to or lower than the air flow rate level of the rear seat blower 12, even if the air flow rates of the front seat blower 40 and the rear seat blower 12 are changed, the change in the air flow rate on the rear seat passenger side does not deviate significantly from the preset air flow rate level.

In this regard, among the rear seat console door opening position control values stored in the memory part 32, the default value K is preferably set to correspond to a case where the opening degree of the rear seat console door 20 with respect to the internal flow path 8a of the console duct 8 is 100%.

Therefore, under the condition that the air flow rate level of the front seat blower 40 is equal to or lower than the air flow rate level of the rear seat blower 12 in the rear seat vent mode, the opening position of the rear seat console door 20 is controlled to a position where the console duct 8 is opened by 100%.

Referring to Table 1 that shows the rear seat console door opening position control values for the air flow rate levels of the front seat blower and the rear seat blower under the rear seat vent mode condition stored in the memory part 32, when the air flow rate level of the front seat blower 40 exceeds the air flow rate level of the rear seat blower 12, the rear seat console door opening position control values are stored as values L, M, N, O, P, Q and R less than the default value K.

Accordingly, under the condition that the air flow rate level of the front seat blower 40 exceeds the air flow rate level of the rear seat blower 12, the opening position of the rear seat console door 20 with respect to the internal flow path 8a of the console duct 8 is controlled to further close the internal flow path 8a of the console duct 8, compared to the condition that the air flow rate level of the front seat blower 40 is equal to or lower than the air flow rate level of the rear seat blower 12.

The reason for adopting this configuration is that, as shown in FIG. 2, under condition that the air flow rate level of the front seat blower 40 exceeds the air flow rate level of the rear seat blower 12, the air flow rate on the console duct 8 side is greatly affected by the discharged air flow rate of the front seat blower 40, and the air flow rate on the console duct 8 side becomes excessively larger than the preset value due to the discharged air flow rate of the front seat blower 40 affected in this way.

In particular, since the air flow rate on the console duct 8 side is excessively larger than the preset value, the discharged air flow rate on the rear seat passenger side does not match the preset air flow rate level.

Accordingly, under the condition that the air flow rate level of the front seat blower 40 exceeds the air flow rate level of the rear seat blower 12, the internal flow path 8a of the console duct 8 is further closed to control the opening amount of the console duct 8 to be small, thereby reducing the excessively large air flow rate on the console duct 8 side.

This makes it possible to compensate for the excessive increase in the air flow rate on the console duct 8 side and the resulting excessive increase in the discharged air flow rate on the rear seat passenger side, and as a result, the discharged air flow rate on the rear seat passenger side can be controlled precisely to the preset air flow level.

Preferably, as shown in Table 1, under the condition that the air flow rate level of the front seat blower 40 exceeds the air flow rate level of the rear seat blower 12, the rear seat console door opening position control values for the air flow rate levels of the front seat blower and the rear seat blower are stored as values less than the default value K, and are stored as values that gradually block the internal flow path 8a of the console duct 8 in inverse proportion to the increase in the difference between the air flow rate levels of the front seat blower 40 and the rear seat blower 12.

For example, as shown in Table 1, under the condition that the air flow rate level of the front seat blower 40 exceeds the air flow rate level of the rear seat blower 12, when the difference between the air flow rate levels of the front seat blower 40 and the rear seat blower 12 gradually increases in the order of 1st level→2nd level→3rd level→4th level→5th level→6th level→7th level, the rear seat console door opening position control values gradually decrease in the order of L→M→N→O→P→Q→R, so that the internal flow path 8a of the console duct 8 is gradually closed.

Accordingly, under the condition that the air flow rate level of the front seat blower 40 exceeds the air flow rate level of the rear seat blower 12, the internal flow path 8a of the console duct 8 is gradually closed in inverse proportion to the increase in the difference between the air flow rate levels of the front seat blower 40 and the rear seat blower 12, so that the air flow rate on the console duct 8 side can be reduced.

The reason for adopting this configuration is that, as shown in FIG. 2, under the condition that the air flow rate level of the front seat blower 40 exceeds the air flow rate level of the rear seat blower 12, the greater the difference between the air flow rate levels of the front seat blower 40 and the rear seat blower 12, the more the air flow rate on the console duct 8 side is affected by the discharged air flow rate of the front seat blower 40.

In particular, since the air flow rate on the console duct 8 side is greatly affected by the discharged air flow rate of the front seat blower 40, the air flow rate on the console duct 8 side becomes excessively large compared to the preset value, and the discharged air flow rate on the rear seat passenger side increases excessively.

As a result, the discharged air flow rate on the rear seat passenger side does not match the preset value, making it impossible to obtain the preset rear seat air flow rate level.

Accordingly, under the condition that the air flow rate level of the front seat blower 40 exceeds the air flow rate level of the rear seat blower 12, when the difference between the air flow rate levels of the front seat blower 40 and the rear seat blower 12 increases, the internal flow path 8a of the console duct 8 is gradually blocked, thereby reducing the air flow rate on the console duct 8 side.

This makes it possible to compensate for the excessive increase in the air flow rate on the console duct 8 side and the resulting excessive increase in the discharged air flow rate on the rear seat passenger side, and as a result, the discharged air flow rate on the rear seat passenger side can be controlled to precisely match the preset air flow rate level.

Referring again to FIG. 2, the control part 30 also controls the on/off operation of the rear seat blower 12 according to the air flow rate levels of the front seat blower 40 and the rear seat blower 12 under the rear seat vent mode condition.

In particular, as shown in Table 2 below, under the rear seat vent mode condition, only if the air flow rate level of the front seat blower 40 exceeds the air flow rate level of the rear seat blower 12, and the difference between the air flow rates of the front seat blower 40 and the rear seat blower 12 is equal to or greater than a preset reference difference, for example, equal to or greater than a 3rd level, the rear seat blower 12 is turned off.

TABLE 2
Control of the on/off operation of the rear seat blower for
the air flow rate levels of the front seat blower and the
rear seat blower under the rear seat vent mode condition

| Control of | | | | | | | | | |
|---|---|---|---|---|---|---|---|---|---|
| on/off | | | | | | | | | |
| operation of | | | | | | | | | |
| rear seat | | Air flow rate level of front seat blower | | | | | | | |
| blower | | 1 | 2 | 3 | 4 | 5 | 6 | 7 | 8 |
| Air flow | 1 | ON | ON | ON | OFF | OFF | OFF | OFF | OFF |
| rate level | 2 | ON | ON | ON | ON | OFF | OFF | OFF | OFF |
| of rear | 3 | ON | ON | ON | ON | ON | OFF | OFF | OFF |
| seat | 4 | ON | ON | ON | ON | ON | ON | OFF | OFF |
| blower | 5 | ON | ON | ON | ON | ON | ON | ON | OFF |
| | 6 | ON | ON | ON | ON | ON | ON | ON | ON |
| | 7 | ON | ON | ON | ON | ON | ON | ON | ON |
| | 8 | ON | ON | ON | ON | ON | ON | ON | ON |

The reason for adopting this configuration is that, under the condition that the air flow rate level of the front seat blower 40 exceeds the air flow rate level of the rear seat blower 12, if the first condition that the air flow rate level of the front seat blower 40 exceeds the air flow rate level of the rear seat blower 12 and the second condition that the difference between the air flow rate levels of the front seat blower 40 and the rear seat blower 12 is the 3rd level or higher are satisfied, the air flow rate on the console duct 8 side is greatly affected by the discharged air flow rate of the front seat blower 40.

In particular, when the first and second conditions are satisfied, the discharged air flow rate of the console duct 8 side can be controlled to a preset air flow rate only by the discharged air flow rate of the front seat blower 40 without the operation of the rear seat blower 12.

Accordingly, when the first and second conditions are satisfied, by turning off the rear seat blower 12, the fuel efficiency of the vehicle can be improved without reducing the cooling and heating effect for the rear seat region.

### Second Embodiment

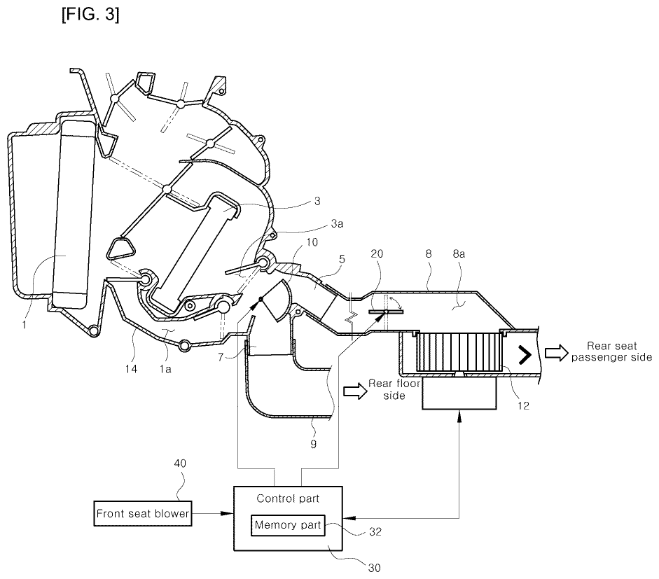

Next, a vehicular air conditioner according to a second embodiment of the present invention will be described with reference to FIG. 3.

Just like the air conditioner according to the first embodiment, the air conditioner according to the second embodiment includes a rear seat console door 20 and a control part 30.

The rear seat console door 20 independently controls the air flow rate of the air blown toward the torso of the rear seat passenger along the console duct 8 by controlling the opening amount of the internal flow path 8a of the console duct 8.

Unlike the control part of the first embodiment which controls only the rear seat console door 20, the control part 30 according to the second embodiment also controls the rear seat mode door 10.

That is, the control part 30 systematically controls the opening degrees of the rear seat mode door 10 and the rear seat console door 20 according to the air flow rate levels of the front seat blower 40 and the rear seat blower 12.

Accordingly, the air is blown to the rear floor side and the rear seat passenger side at an air flow rate that matches the current rear seat air discharge mode and the preset air flow rate level.

In particular, when the rear seat air discharge mode is a bi-level mode, the opening degree of the rear seat mode door 10 for the rear floor vent 7 and the opening degree of the rear seat console door 20 for the internal flow path 8a of the console duct 8 are systematically controlled according to the air flow rate levels of the front seat blower 40 and the rear seat blower 12.

Accordingly, the air in the air flow rate corresponding to the rear seat bi-level mode condition and the air flow rate level condition set by the user or according to the internal/external temperature condition can be blown to the rear floor side and the rear seat passenger side.

In more detail, the control part 30 includes a memory part 32.

As shown in Table 3 below, the memory part 32 stores a mapping table that indicates the control values of the opening position of the rear seat mode door for the air flow rate levels of the front seat blower and the rear seat blower under the rear seat bi-level mode condition.

TABLE 3
Control values of the opening position of the rear seat mode
door for the air flow rate levels of the front seat blower and
the rear seat blower under the rear seat bi-level mode condition
(floor vent opening amount: A > B > C > D > E > F > G > H)

| Control value of opening | | | | | | | | | |
|---|---|---|---|---|---|---|---|---|---|
| position of rear seat | | Air flow rate level of front seat blower | | | | | | | |
| mode door (V) | | 1 | 2 | 3 | 4 | 5 | 6 | 7 | 8 |
| Air flow rate level | 1 | A | B | C | D | E | F | G | H |
| of rear seat blower | 2 | A | A | B | C | D | E | F | G |
| | 3 | A | A | A | B | C | D | E | F |
| | 4 | A | A | A | A | B | C | D | E |
| | 5 | A | A | A | A | A | B | C | D |
| | 6 | A | A | A | A | A | A | B | C |
| | 7 | A | A | A | A | A | A | A | B |
| | 8 | A | A | A | A | A | A | A | A |

The control values of the opening position of the rear seat mode door for the air flow rate levels of the front seat blower and the rear seat blower are correction values of the opening position of the rear seat mode door 10 for correcting the air flow rates of the air blown to the rear floor side and changed depending on the air flow rate levels of the front seat blower 40 and the rear seat blower 12 in the rear seat bi-level mode to match preset rear seat air flow rate levels, and are stored differently for the air flow rate levels of the front seat blower 40 and the rear seat blower 12.

As shown in Table 4 below, the memory part 32 stores a mapping table that indicates the control values of the opening position of the rear seat console door for the air flow rate levels of the front seat blower and the rear seat blower under the rear seat bi-level mode condition.

TABLE 4
Control values of the opening position of the rear seat console door
for the air flow rate levels of the front seat blower and the rear
seat blower under the rear seat bi-level mode condition (console duct
internal flow path opening amount: K > L > M > N > O > P > Q > R)

| Control value of opening | | | | | | | | | |
|---|---|---|---|---|---|---|---|---|---|
| position of rear seat | | Air flow rate level of front seat blower | | | | | | | |
| console door (V) | | 1 | 2 | 3 | 4 | 5 | 6 | 7 | 8 |
| Air flow rate level | 1 | K | L | M | N | O | P | Q | R |
| of rear seat blower | 2 | K | K | L | M | N | O | P | Q |
| | 3 | K | K | K | L | M | N | O | P |
| | 4 | K | K | K | K | L | M | N | O |
| | 5 | K | K | K | K | K | L | M | N |
| | 6 | K | K | K | K | K | K | L | M |
| | 7 | K | K | K | K | K | K | K | L |
| | 8 | K | K | K | K | K | K | K | K |

The control values of the opening position of the rear seat console door for the air flow rate levels of the front seat blower and the rear seat blower are correction values of the opening position of the rear seat console door 20 for correcting the air flow rates of the air blown to the rear seat passenger side and changed depending on the air flow rate levels of the front seat blower 40 and the rear seat blower 12 in the rear seat bi-level mode to match preset rear seat air flow rate levels, and are stored differently for the air flow rate levels of the front seat blower 40 and the rear seat blower 12.

Meanwhile, if it is determined that the current rear seat air discharge mode is a bi-level mode, the control part 30 detects from the memory part 32 the control value of the opening position of the rear seat mode door corresponding to the current air flow rate level of the front seat blower and the current air flow rate level of the rear seat blower inputted from the front seat blower 40 and the rear seat blower 12, and the control value of the opening position of the rear seat consol door.

When the control value of the opening position of the rear seat mode door and the control value of the opening position of the rear seat consol door have been detected, the control part 30 variably controls the opening position of the rear seat mode door 10 and the opening position of the rear seat console door 20 based on the detected control value of the opening position of the rear seat mode door and the detected control value of the opening position of the rear seat console door.

In particular, the control part 30 controls the opening position of the rear seat mode door 10 for the rear floor vent 7 and the opening position of the rear seat console door 20 for the internal flow path 8a of the console duct 8.

Accordingly, when the air flow rate levels of the front seat blower 40 and the rear seat blower 12 are varied by the user settings or the internal/external temperature conditions in the rear seat vi-level mode, and the air flow rate of the air blown to the rear floor side and the rear seat passenger side is changed differently from the preset rear seat air flow rate level, the opening position of the rear seat mode door 10 and the opening position of the rear seat console door 20 can be corrected in response thereto.

Thus, the discharged air flow rates on the rear floor side and the rear seat passenger side can be corrected to match the preset air flow rate levels even when the air flow rate levels of the front seat blower 40 and the rear seat blower 12 are varied in the rear seat bi-level mode.

As a result, regardless of the change in the air flow rate level of the front seat blower 40 and the rear seat blower 12, the discharged air flow rates on the rear floor side and the rear seat passenger side are controlled to match the preset air flow rate levels, thereby keeping the rear seat region comfortable.

Meanwhile, as shown in Tables 3 and 4 that show the rear seat mode door opening position control values and the rear seat console door opening position control values for the air flow rate levels of the front seat blower and the rear seat blower under the rear seat bi-level mode condition stored in the memory part 32, the rear seat mode door opening position control values and the rear seat console door opening position control values are stored as preset default values A and K, respectively, under the condition that the air flow rate level of the front seat blower 40 is equal to or lower than the air flow rate level of the rear seat blower 12, i.e., under the condition that the air flow rate level of the front seat blower 40 is not higher than the air flow rate level of the rear seat blower 12.

Accordingly, under the condition that the air flow rate level of the front seat blower 40 is equal to or lower than the air flow rate level of the rear seat blower 12, the opening position of the rear seat mode door 10 with respect to the rear floor vent 7 and the opening position of the rear seat console door 20 with respect to the internal flow path 8a of the console duct 8 are constantly controlled to preset positions regardless of the air flow rates of the front seat blower 40 and the rear seat blower 12.

The reason for adopting this configuration is that, under the condition that the air flow rate level of the front seat blower 40 is equal to or lower than the air flow rate level of the rear seat blower 12, even if the air flow rates of the front seat blower 40 and the rear seat blower 12 are changed, the changes in the air flow rates on the rear floor side and the rear seat passenger side do not deviate significantly from the preset air flow rate levels.

In this regard, among the rear seat mode door opening position control values stored in the memory part 32, the default value A is preferably set to correspond to a case where the opening degree of the rear seat mode door 10 with respect to the rear floor vent 7 is 44%.

Furthermore, among the rear seat console door opening position control values stored in the memory part 32, the default value K is preferably set to correspond to a case where the opening degree of the rear seat console door 20 with respect to the internal flow path 8a of the console duct 8 is 100%.

Therefore, under the condition that the air flow rate level of the front seat blower 40 is equal to or lower than the air flow rate level of the rear seat blower 12 in the rear seat bi-level mode, the opening position of the rear seat mode door 10 is controlled to a position where the rear floor vent 8 is opened by 44%, and the opening position of the rear seat console door 20 is controlled to a position where the console duct 8 is opened by 100%.

Referring to Table 3 that shows the rear seat mode door opening position control values for the air flow rate levels of the front seat blower and the rear seat blower under the rear seat bi-level mode condition stored in the memory part 32, when the air flow rate level of the front seat blower 40 exceeds the air flow rate level of the rear seat blower 12, the rear seat mode door opening position control values are stored as values B, C, D, E, F, G and H less than the default value A.

Accordingly, under the condition that the air flow rate level of the front seat blower 40 exceeds the air flow rate level of the rear seat blower 12, the opening position of the rear seat mode door 10 with respect to the rear floor vent 7 is controlled to further close the rear floor vent 7, compared to the condition that the air flow rate level of the front seat blower 40 is equal to or lower than the air flow rate level of the rear seat blower 12.

The reason for adopting this configuration is that, as shown in FIG. 3, under condition that the air flow rate level of the front seat blower 40 exceeds the air flow rate level of the rear seat blower 12, when the air flow rate levels of the front seat blower 40 and the rear seat blower 12 are changed, the change in the discharged air flow rates on the rear floor side and the rear seat passenger side is greatly deviated from a preset value.

In particular, under the condition that the air flow rate level of the front seat blower 40 exceeds the air flow rate level of the rear seat blower 12, the air flow rate of the air discharged to the rear floor surface through the rear floor vent 7 and the rear floor duct 9 is relatively large, and the distribution ratio with the air flow rate of the air discharged to the rear seat passenger side does not match the set value.

Accordingly, under the condition that the air flow rate level of the front seat blower 40 exceeds the air flow rate level of the rear seat blower 12, the rear floor vent 7 is further closed to reduce the opening amount of the rear floor vent 7, thereby reducing the air flow rate of the air discharged toward the rear floor vent 7 and the rear floor duct 7 and reducing the air flow rate of the air discharged toward the rear floor.

As a result, it is possible to compensate for the increase in the air flow rate of the air discharged toward the rear floor that occurs under the condition that the air flow rate level of the front seat blower 40 exceeds the air flow rate level of the rear seat blower 12, and the resulting difference in the air distribution ratio between the rear floor side and the rear seat passenger side.

Preferably, as shown in Table 3, under the condition that the air flow rate level of the front seat blower 40 exceeds the air flow rate level of the rear seat blower 12, the rear seat mode door opening position control values for the air flow rate levels of the front seat blower and the rear seat blower are stored as values less than the default value A, and are stored as values that gradually block the rear floor vent 7 in inverse proportion to the increase in the difference between the air flow rate levels of the front seat blower 40 and the rear seat blower 12.

For example, as shown in Table 3, under the condition that the air flow rate level of the front seat blower 40 exceeds the air flow rate level of the rear seat blower 12, when the difference between the air flow rate levels of the front seat blower 40 and the rear seat blower 12 gradually increases in the order of 1st level→2nd level→3rd level→4th level→5th level→6th level→7th level, the rear seat mode door opening position control values gradually decrease in the order of B→C→D→E→F→G→H, so that the rear floor vent 7 is gradually closed.

Accordingly, under the condition that the air flow rate level of the front seat blower 40 exceeds the air flow rate level of the rear seat blower 12, the rear floor vent 7 is gradually closed in proportion to the increase in the difference between the air flow rate levels of the front seat blower 40 and the rear seat blower 12, so that the air flow rate on the rear floor duct 9 side can be reduced.

The reason for adopting this configuration is that, as shown in FIG. 3, under the condition that the air flow rate level of the front seat blower 40 exceeds the air flow rate level of the rear seat blower 12, when the difference between the air flow rates of the front seat blower 40 and the rear seat blower 12 increases, the air flow rate on the rear floor duct 9 side increases relatively in proportion thereto, compared to the air flow rate on the console duct 8 side.

Therefore, under the condition that the air flow rate level of the front seat blower 40 exceeds the air flow rate level of the rear seat blower 12, when the difference between the air flow rates of the front seat blower 40 and the rear seat blower 12 increases, the rear floor vent 7 is gradually blocked, thereby gradually reducing the air flow rate on the rear floor duct 9 side.

This makes it possible to compensate for the difference between the increased air flow rate on the rear floor duct 9 side and the resulting air flow rate on the console duct 8 side. As a result, it is possible to compensate for the difference in the air distribution ratio between the rear floor side and the rear seat passenger side due to the increased air flow rate discharged toward the rear floor side.

Referring again to FIG. 3, as shown in Table 4 that shows the rear seat console door opening position control values for the air flow rate levels of the front seat blower and the rear seat blower under the rear seat bi-level mode condition stored in the memory part 32, when the air flow rate level of the front seat blower 40 exceeds the air flow rate level of the rear seat blower 12, the rear seat console door opening position control values are stored as values L, M, N, O, P, Q and R less than the default value K.

Accordingly, under the condition that the air flow rate level of the front seat blower 40 exceeds the air flow rate level of the rear seat blower 12, the opening position of the rear seat console door 20 with respect to the internal flow path 8a of the console duct 8 is controlled to further close the internal flow path 8a of the console duct 8, compared to the condition that the air flow rate level of the front seat blower 40 is equal to or lower than the air flow rate level of the rear seat blower 12.

The reason for adopting this configuration is that, as shown in FIG. 3, under condition that the air flow rate level of the front seat blower 40 exceeds the air flow rate level of the rear seat blower 12, the air flow rate on the console duct 8 side is greatly affected by the discharged air flow rate of the front seat blower 40, and the air flow rate on the console duct 8 side becomes excessively larger than the preset value due to the discharged air flow rate of the front seat blower 40 affected in this way.

In particular, since the air flow rate on the console duct 8 side is excessively larger than the preset value, the distribution ratio between the discharged air flow rates on the rear seat passenger side and the rear floor side does not match a preset value.

Accordingly, under the condition that the air flow rate level of the front seat blower 40 exceeds the air flow rate level of the rear seat blower 12, the internal flow path 8a of the console duct 8 is further closed to control the opening amount of the console duct 8 to be small, thereby reducing the excessively large air flow rate on the console duct 8 side.

This makes it possible to compensate for the excessive increase in the air flow rate on the console duct 8 side and the resulting difference between the air flow rates on the console duct 8 side and the rear floor duct 9 side. As a result, it is possible to compensate for the difference in the air distribution ratio between the rear seat passenger side and the rear floor side due to the excessive increase in the air flow rate on the console duct 8 side.

Preferably, as shown in Table 4, under the condition that the air flow rate level of the front seat blower 40 exceeds the air flow rate level of the rear seat blower 12, the rear seat console door opening position control values for the air flow rate levels of the front seat blower and the rear seat blower are stored as values less than the default value K, and are stored as values that gradually block the internal flow path 8a of the console duct 8 in inverse proportion to the increase in the difference between the air flow rate levels of the front seat blower 40 and the rear seat blower 12.

For example, as shown in Table 4, under the condition that the air flow rate level of the front seat blower 40 exceeds the air flow rate level of the rear seat blower 12, when the difference between the air flow rate levels of the front seat blower 40 and the rear seat blower 12 gradually increases in the order of 1st level→2nd level→3rd level→4th level→5th level→6th level→7th level, the rear seat console door opening position control values gradually decrease in the order of L→M→N→O→P→Q→R, so that the internal flow path 8a of the console duct 8 is gradually closed.

Accordingly, under the condition that the air flow rate level of the front seat blower 40 exceeds the air flow rate level of the rear seat blower 12, the internal flow path 8a of the console duct 8 is gradually closed in inverse proportion to the increase in the difference between the air flow rate levels of the front seat blower 40 and the rear seat blower 12, so that the air flow rate on the console duct 8 side can be reduced.

The reason for adopting this configuration is that, as shown in FIG. 3, under the condition that the air flow rate level of the front seat blower 40 exceeds the air flow rate level of the rear seat blower 12, the greater the difference between the air flow rate levels of the front seat blower 40 and the rear seat blower 12, the more the air flow rate on the console duct 8 side is affected by the discharged air flow rate of the front seat blower 40.

In particular, since the air flow rate on the console duct 8 side is greatly affected by the discharged air flow rate of the front seat blower 40, the air flow rate on the console duct 8 side becomes excessively large compared to the preset value, and the discharged air flow rate on the rear seat passenger side increases excessively compared to the discharged air flow rate on the rear floor side.

As a result, the distribution ratio between the discharged air flow rates on the rear seat passenger side and the rear floor side does not match the preset value, making it impossible to obtain the preset rear seat air flow rate level.

Accordingly, under the condition that the air flow rate level of the front seat blower 40 exceeds the air flow rate level of the rear seat blower 12, when the difference between the air flow rate levels of the front seat blower 40 and the rear seat blower 12 increases, the internal flow path 8a of the console duct 8 is gradually blocked, thereby reducing the air flow rate on the console duct 8 side.

This makes it possible to compensate for the excessive increase in the air flow rate on the console duct 8 side and the resulting distribution ratio difference between the air flow rates on the console duct 8 side and the rear floor duct 9 side. As a result, the air distribution ratio on the rear seat passenger side and the rear floor side can be controlled to match the preset value.

Referring again to FIG. 3, the control part 30 also controls the on/off operation of the rear seat blower 12 according to the air flow rate levels of the front seat blower 40 and the rear seat blower 12 under the rear seat bi-level mode condition.

In particular, as shown in Table 5 below, under the rear seat bi-level mode condition, only if the air flow rate level of the front seat blower 40 exceeds the air flow rate level of the rear seat blower 12, and the difference between the air flow rates of the front seat blower 40 and the rear seat blower 12 is equal to or greater than a preset reference difference, for example, equal to or greater than a 3rd level, the rear seat blower 12 is turned off.

TABLE 5
Control of the on/off operation of the rear seat blower for
the air flow rate levels of the front seat blower and the
rear seat blower under the rear seat bi-level mode condition

| Control of | | | | | | | | | |
|---|---|---|---|---|---|---|---|---|---|
| on/off | | | | | | | | | |
| operation of | | | | | | | | | |
| rear seat | | Air flow rate level of front seat blower | | | | | | | |
| blower | | 1 | 2 | 3 | 4 | 5 | 6 | 7 | 8 |
| Air flow | 1 | ON | ON | ON | OFF | OFF | OFF | OFF | OFF |
| rate level | 2 | ON | ON | ON | ON | OFF | OFF | OFF | OFF |
| of rear | 3 | ON | ON | ON | ON | ON | OFF | OFF | OFF |
| seat | 4 | ON | ON | ON | ON | ON | ON | OFF | OFF |
| blower | 5 | ON | ON | ON | ON | ON | ON | ON | OFF |
| | 6 | ON | ON | ON | ON | ON | ON | ON | ON |
| | 7 | ON | ON | ON | ON | ON | ON | ON | ON |
| | 8 | ON | ON | ON | ON | ON | ON | ON | ON |

The reason for adopting this configuration is that, under the condition that the air flow rate level of the front seat blower 40 exceeds the air flow rate level of the rear seat blower 12, if the first condition that the air flow rate level of the front seat blower 40 exceeds the air flow rate level of the rear seat blower 12 and the second condition that the difference between the air flow rate levels of the front seat blower 40 and the rear seat blower 12 is the 3^{rd} level or higher are satisfied, the air flow rate on the console duct 8 side is greatly affected by the discharged air flow rate of the front seat blower 40.

In particular, when the first and second conditions are satisfied, the discharged air flow rate of the console duct 8 side can be controlled to a preset air flow rate only by the discharged air flow rate of the front seat blower 40 without the operation of the rear seat blower 12.

Accordingly, when the first and second conditions are satisfied, by turning off the rear seat blower 12, the fuel efficiency of the vehicle can be improved without reducing the cooling and heating effect for the rear seat region.

According to the present air conditioner having such a configuration, since the rear seat console door 20 is installed on the console duct 8 side and the rear seat console door 20 is individually controlled by the control part 30, it is possible to individually control the air flow rate on the console duct 8 side.

In addition, since the air flow rate on the console duct 8 side can be individually adjusted, the air flow rate of the air blown toward the rear seat passenger side through the console duct 8 can be precisely controlled according to the preset value and the preset air flow rate level.

In addition, since the rear seat console door 20 is individually controlled, the air flow rate on the console duct 8 side can be accurately controlled to the preset value in the rear seat vent mode.

In addition, since the air flow rate on the console duct 8 side can be precisely controlled to the preset value in the rear seat vent mode, the blown air flow rate and the air flow rate level on the rear seat passenger side can be controlled to the preset values in the rear seat vent mode, thereby improving the comfort in the rear seat region.

In addition, since the rear seat console door 20 is controlled according to the air flow rate levels of the front seat blower 40 and the rear seat blower 12 in the rear seat vent mode, the air flow rate on the console duct 8 side can be variably adjusted according to the air flow rate levels of the front seat blower 40 and the rear seat blower 12 in the rear seat vent mode.

In addition, since the air flow rate on the console duct 8 side can be variably adjusted according to the air flow rate levels of the front seat blower 40 and the rear seat blower 12 in the rear seat vent mode, it is possible to actively respond to the change in the air flow rate on the console duct 8 side that occurs according to the change in the air flow rate levels of the front seat blower 40 and the rear seat blower 12 under the rear seat vent mode condition.

In addition, since it is possible to actively respond to the change in the air flow rate on the console duct 8 side that occurs according to the change in the air flow rate levels of the front seat blower 40 and rear seat blower 12 under the rear seat vent mode condition, it is possible to compensate for the change in the air flow rate on the rear seat passenger side that occurs when the air flow rates in the front seat blower 40 and rear seat blower 12 are changed.

In addition, since it is possible to compensate for the change in the air flow rate on the rear seat passenger side that occurs when the air flow rate levels of the front seat blower 40 and the rear seat blower 12 are changed under the rear seat vent mode condition, the discharged air flow rate on the rear seat passenger side can be controlled to match the preset air flow rate level regardless of the change in the air flow rate levels of the front seat blower 40 and the rear seat blower 12 in the rear seat vent mode.

In addition, since the rear seat console door 20 is installed on the console duct 8 side and the rear seat console door 20 and the rear seat mode doors 10 are individually controlled by the control part 30, it is possible to individually control the air flow rate on the rear floor duct 9 side and the air flow rate on the console duct 8 side.

In addition, since the air flow rate on the rear floor duct 9 side and the air flow rate on the console duct 8 side can be individually controlled, the air flow rate of the air blown to the rear floor side through the rear floor duct 9 and the air flow rate of the air blown to the rear seat passenger side through the console duct 8 can be precisely controlled according to the preset value and the preset air flow rate level.

In addition, since the rear seat console door 20 and the rear seat mode doors 10 are individually controlled in a systematically controlled manner, the air flow rate distribution between the rear floor duct 9 side and the console duct 8 side and the respective air flow rates can be precisely controlled to the preset values in the rear seat bi-level mode.

In addition, since the air flow rate distribution between the rear floor duct 9 side and the console duct 8 side and the respective air flow rates can be precisely controlled to the preset values in the rear seat bi-level mode, the air flow rate and the air flow levels on the rear floor side and the rear seat passenger side can be controlled to the preset values in the rear seat bi-level mode, thereby improving the comfort in the rear seat region.

In addition, since the rear seat console door 20 and the rear seat mode doors 10 are systematically controlled according to the air flow levels of the front seat blower 40 and the rear seat blower 12 in the rear seat bi-level mode, the air flow rate on the rear floor duct 9 side and the air flow rate on the console duct 8 side can be variably adjusted according to the air flow levels of the front seat blower 40 and the rear seat blower 12 in the rear seat bi-level mode.

In addition, since the air flow rate on the rear floor duct 9 side and the air flow rate on the console duct 8 side can be variably controlled according to the air flow rate levels of the front seat blower 40 and the rear seat blower 12 in the rear seat bi-level mode, it is possible to actively respond to the change in the air flow rate on the rear floor duct 9 side and the air flow rate on the console duct 8 side that occurs according to the change in the air flow rate levels of the front seat blower 40 and the rear seat blower 12 under the rear seat bi-level mode condition.

In addition, since it is possible to actively respond to the change in the air flow rate on the rear floor duct 9 side and the air flow rate on the console duct 8 side that occurs according to the change in the air flow rate levels of the front seat blower 40 and the rear seat blower 12 under the rear seat bi-level mode condition, it is possible to compensate for the changes in the air flow rates on the rear floor side and the rear seat passenger side that occur when the air flow rate levels of the front seat blower 40 and the rear seat blower 12 are changed.

In addition, since it is possible to compensate for the changes in the air flow rates on the rear floor side and the rear seat passenger side that occur when the air flow rate levels of the front seat blower 40 and the rear seat blower 12 are changed under the rear seat bi-level mode condition, the discharged air flow rates on the rear floor side and the rear seat passenger side can be controlled to match the preset air flow rate levels regardless of the change in the air flow rate levels of the front seat blower 40 and the rear seat blower 12 in the rear seat bi-level mode.

While the preferred embodiments of the present invention have been described above, the present invention is not limited to the above-described embodiments. Various modifications and changes may be made without departing from the scope and spirit of the present invention defined in the claims.

1. A vehicular air conditioner, comprising:
a console duct and a rear floor duct configured to blow air discharged from a front seat blower to a rear seat passenger side and a rear floor side, respectively;
a rear seat mode door configured to control air distribution from the front seat blower to the console duct and the rear floor duct;
a rear seat blower installed in the console duct so as to increase an air flow rate and an air pressure of the air blown to the rear seat passenger side;
a rear seat console door installed in an internal passage of the console duct so as to adjust the air flow rate of air blown to the rear seat passenger side along the console duct; and
a control part configured to control an opening position of the rear seat console door with respect to the console duct so as to blow the air to the rear seat passenger side at an air flow rate corresponding to a preset air flow rate level.

2. The vehicular air conditioner of claim 1, wherein the rear seat console door is installed on the internal flow path of the console duct on the upstream side of the rear seat blower.

3. The vehicular air conditioner of claim 2, wherein the control part is configured to, when a rear seat air discharge mode is a rear seat vent mode, control the opening position of the rear seat console door with respect to the console duct according to air flow rate levels of the front seat blower and the rear seat blower, so that the air can be blown to the rear seat passenger side at an air flow rate corresponding to the rear seat vent mode and the preset air flow rate level.

4. The vehicular air conditioner of claim 3, wherein the control part is configured to constantly control the opening position of the rear seat console door with respect to the console duct to a preset position under a condition that the air flow rate level of the front seat blower is equal to or lower than the air flow rate level of the rear seat blower in the rear seat vent mode.

5. The vehicular air conditioner of claim 4, wherein, under a condition that the air flow rate level of the front seat blower exceeds the air flow rate level of the rear seat blower in the rear seat vent mode, the control part controls the opening position of the rear seat console door with respect to the console duct to a position where the console duct is closed more than under a condition that the air flow rate level of the front seat blower is equal to or lower than the air flow rate level of the rear seat blower.

6. The vehicular air conditioner of claim 5, wherein, under a condition that the air flow rate level of the front seat blower exceeds the air flow rate level of the rear seat blower in the rear seat vent mode, the control part controls the opening position of the rear seat console door so as to gradually block the console duct in inverse proportion to an increase in a difference between the air flow rate levels of the front seat blower and the rear seat blower.

7. The vehicular air conditioner of claim 6, wherein the control part is configured to control an on/off operation of the rear seat blower according to the air flow rate levels of the front seat blower and the rear seat blower in the rear seat vent mode.

8. The vehicular air conditioner of claim 7, wherein the control part is configured to turn off the rear seat blower only if the air flow rate level of the front seat blower exceeds the air flow rate level of the rear seat blower, and the difference between the air flow rates of the front seat blower and the rear seat blower is equal to or greater than a preset reference difference in the rear seat vent mode.

9. The vehicular air conditioner of claim 8, wherein, under a condition that the air flow rate level of the front seat blower is equal to or lower than the air flow rate level of the rear seat blower in the rear seat vent mode, the control part controls the opening position of the rear seat console door with respect to the console duct to a position where the console duct is opened by 100%.

10. The vehicular air conditioner of claim 9, wherein the control part is configured to store a mapping table that indicates control values of the opening position of the rear seat console door for the air flow rate levels of the front seat blower and the rear seat blower in the rear seat vent mode,
the control part is configured to, when entering the rear seat vent mode, detect a control value of the opening position of the rear seat console door corresponding to a current air flow rate level of the front seat blower and a current air flow rate level of the rear seat blower, and
the control part is configured to variably control the opening position of the rear seat console door with respect to the console duct based on the detected control value of the opening position of the rear seat console door.

11. The vehicular air conditioner of claim 1, wherein the control part is configured to control an opening position of the rear seat console door with respect to the console duct and an opening position of the rear seat mode door with respect to the console duct and the rear floor duct so as to blow the air toward the rear floor side and the rear seat passenger side at an air flow rate that matches a current rear seat air discharge mode and a preset air flow rate level.

12. The vehicular air conditioner of claim 11, wherein the rear seat console door is installed in the internal flow path of the console duct on the upstream side of the rear seat blower.

13. The vehicular air conditioner of claim 12, wherein when the rear seat air discharge mode is a bi-level mode, the control part systematically controls the rear seat mode door and the rear seat console door according to the air flow rate levels of the front seat blower and the rear seat blower so as to blow the air toward the rear floor side and the rear seat passenger side at an air flow rate that matches the rear seat bi-level mode and the preset air flow rate level.

14. The vehicular air conditioner of claim 13, wherein the control part is configured to constantly control the opening position of the rear seat mode door with respect to the rear floor duct and the opening position of the rear seat console door with respect to the console duct to preset positions under a condition that the air flow rate level of the front seat blower is equal to or lower than the air flow rate level of the rear seat blower in the rear seat bi-level mode.

15. The vehicular air conditioner of claim 14, wherein, under a condition that the air flow rate level of the front seat blower exceeds the air flow rate level of the rear seat blower in the rear seat bi-level mode, the control part controls the opening position of the rear seat mode door with respect to the rear floor duct to a position where the rear floor duct is closed more than under a condition that the air flow rate level of the front seat blower is equal to or lower than the air flow rate level of the rear seat blower.

16. The vehicular air conditioner of claim 15, wherein, under a condition that the air flow rate level of the front seat blower exceeds the air flow rate level of the rear seat blower in the rear seat vent mode, the control part controls the opening position of the rear seat mode door so as to gradually block the rear floor duct in inverse proportion to an increase in a difference between the air flow rate levels of the front seat blower and the rear seat blower.

17. The vehicular air conditioner of claim 16, wherein, under a condition that the air flow rate level of the front seat blower exceeds the air flow rate level of the rear seat blower in the rear seat bi-level mode, the control part controls the opening position of the rear seat console door with respect to the console duct to a position where the console duct is closed more than under a condition that the air flow rate level of the front seat blower is equal to or lower than the air flow rate level of the rear seat blower.

18. The vehicular air conditioner of claim 17, wherein, under a condition that the air flow rate level of the front seat blower exceeds the air flow rate level of the rear seat blower in the rear seat bi-level mode, the control part controls the opening position of the rear seat console door so as to gradually block the console duct in inverse proportion to an increase in a difference between the air flow rate levels of the front seat blower and the rear seat blower.

19. The vehicular air conditioner of claim 18, wherein the control part is configured to control an on/off operation of the rear seat blower according to the air flow rate levels of the front seat blower and the rear seat blower in the rear seat bi-level mode.

20. The vehicular air conditioner of claim 19, wherein the control part is configured to turn off the rear seat blower only if the air flow rate level of the front seat blower exceeds the air flow rate level of the rear seat blower, and the difference between the air flow rates of the front seat blower and the rear seat blower is equal to or greater than a preset reference difference in the rear seat bi-level mode.

21. The vehicular air conditioner of claim 20, wherein, under a condition that the air flow rate level of the front seat blower is equal to or lower than the air flow rate level of the rear seat blower in the rear seat bi-level mode, the control part controls the opening position of the rear seat mode door with respect to the rear floor duct to a position where the rear floor duct is opened by 44%.

22. The vehicular air conditioner of claim 21, wherein, under a condition that the air flow rate level of the front seat blower is equal to or lower than the air flow rate level of the rear seat blower in the rear seat bi-level mode, the control part controls the opening position of the rear seat console door with respect to the console duct to a position where the console duct is opened by 100%.

23. The vehicular air conditioner of claim 22, wherein the control part is configured to store a mapping table that indicates control values of the opening position of the rear seat console door for the air flow rate levels of the front seat blower and the rear seat blower in the rear seat bi-level mode,
the control part is configured to, when entering the rear seat bi-level mode, detect a control value of the opening position of the rear seat mode door and a control value of the opening position of the rear seat console door corresponding to a current air flow rate level of the front seat blower and a current air flow rate level of the rear seat blower, and
the control part is configured to variably control the opening position of the rear seat mode door with respect to the rear floor duct and the opening position of the rear seat console door with respect to the console duct based on the detected control value of the opening position of the rear seat mode door and the detected control value of the opening position of the rear seat console door.
